(19) United States
(12) Patent Application Publication
(10) Pub. No.: US 2020/0015273 A1
(43) Pub. Date: Jan. 9, 2020

(54) METHODS AND APPARATUS FOR ENHANCED RANDOM ACCESS PROCEDURE

(71) Applicants: Yuanyuan ZHANG, Beijing (CN); Tao CHEN, Beijing (CN); MEDIATEK SINGAPORE PTE. LTD., Singapore (SG)

(72) Inventors: Yuanyuan ZHANG, Beijing (CN); Tao CHEN, Beijing (CN)

(73) Assignee: MEDIATEK SINGAPORE PTE. LTD., Singapore (SG)

(21) Appl. No.: 16/310,223

(22) PCT Filed: Mar. 23, 2018
(86) PCT No.: PCT/CN2018/080210

§ 371 Date: Dec. 14, 2018

(30) Foreign Application Priority Data
Mar. 24, 2017 (CN) PCT/CN2017/078079

(51) Int. Cl. H04W 74/08; H04W 24/10; H04L 5/00; H04W 72/04; H04W 76/11; H04W 76/27; H04W 74/02

(52) U.S. Cl. CPC H04W 74/0833; H04W 24/10; H04L 5/0051; H04W 74/02; H04W 76/11; H04W 76/27; H04W 72/046

(57) ABSTRACT

A transmitted reference signal in measured as received through receiver beams having associated receiver beam identities. The reference signal measurements are stored in association with identities of transmitter beams over which the reference signal was transmitted and with the corresponding receiver beam identities to define respective beam link pair measurements. A beam link pair is selected that meets a criterion on the beam link pair measurements and a random access procedure is initiated by transmitting a preamble message over a transmitter beam of the selected beam link pair.

### CROSS REFERENCE TO RELATED APPLICATIONS

This application claims priority from PCT Application Number PCT/CN2017/078079 filed on Mar. 24, 2017; the subject matter of which is incorporated herein by reference.

### TECHNICAL FIELD

The disclosed embodiments relate generally to wireless communication, and more particularly, to random access (RA) procedure in the Fifth Generation (5G) new radio (NR) access system with beamforming.

### BACKGROUND

The incredible growing demand for cellular data inspires interest in high frequency (HF) communication systems. One of the objectives of 5G is to support frequency ranges up to 100 GHz in an HF band where the available spectrum is 200 times greater than conventional cellular systems.

5G radio access technology will be a key component of modern access networks. It will address high traffic growth and increasing demand for high-bandwidth connectivity. It will also support massive numbers of connected devices as well as meet the real-time and high-reliability communication needs of mission-critical applications. A standalone NR deployment and non-standalone NR deployment that relies on long term evolution (LTE)/eLTE (enhanced LTE) are being considered.

Radio access to such access networks is achieved through a random access procedure. FIG. 10 is a sequence diagram of a conventional random access procedure (contention based) by which user equipment (UE) 1010 and a base station (BS) 1050 connect at the radio level. At 1015, UE 1010 selects one of 64 available random access channel (RACH) preambles and sends the preamble in a timeslot that temporarily identifies UE 1010 to the network, i.e., radio network temporary identity (RA-RNTI). This is conventionally referred to as message 1 (MSG1).

At 1020, BS 1050 sends a random access response (RAR) to the RA-RNTI of UE 1010 on downlink shared channel (DL-SCH). This is conventionally referred to as message 2 (MSG2) and contains a temporary cell radio network temporary identity (Temporary C-RNTI) for UE 1010, a timing advance value by which UE 1010 is informed how to compensate for the round trip delay between UE 1010 and BS 1050, and an uplink grant resource by which UE 1010 can use the uplink shared channel (UL-SCH).

At 1025, UE 1010 sends a radio resource control (RRC) connection request message on UL-SCH to BS 1050 using its Temporary C-RNTI. This is conventionally referred to as message 3 (MSG3) and contains a UE identity (temporary mobile subscriber identity (TMSI) if UE 1010 has previously connected to the same network or a random value if UE 1010 is connecting for the very first time to network) and connection establishment cause, i.e., the reason for which UE 1010 is connecting to the network.

At 1030, BS 1050 responds with a contention resolution message, conventionally referred to as message 4. This message is addressed to the temporary C-RNTI and contains the TMSI. The Temporary C-RNTI is promoted to C-RNTI for a UE which detects RA success and does not already have a C-RNTI.

The random access procedure is performed for the following events: initial access from RRC_IDLE, RRC Connection Re-establishment, Handover, DL data arrival, UL data arrival, and positioning and beam failure recovery.

Taking initial access as example, prior to conducting a random access procedure, UE 1010 and BS 1050 need to synchronize through an initial synchronization processes. Once synchronized, the UE can read the master information block and system information blocks to check whether it is attempting to connect to the appropriate public land mobile network (PLMN). Assuming that UE 1010 finds the PLMN value to be correct, UE 1010 will proceed with reading system information block 1 and system information block 2. At this stage, the UE has no resource or channel by which it can inform the network about its desire to connect.

The very short wavelengths of HF accommodate a large number of miniaturized antennas placed in small area, such as to form a very high gain, electrically steerable array, where by high directional transmissions are achieved through beamforming. Beamforming compensates for high-frequency propagation loss through a high antenna gain. The reliance on highly directional communications and its vulnerability to the propagation environment introduce particular challenges including intermittent connectivity and rapidly variable signal strength. HF communications will depend extensively on adaptive beamforming at a scale that far exceeds the current cellular systems.

The reliance on directional transmission of synchronization and broadcast signals may delay base station detection during cell search operations for initial connection setup or handover, since both the base station and the mobile stations need to scan over a range of beam angles before they detect each other. When a UE performs a random access procedure, the UE also needs to scan over a range of angles during preamble transmission, so that it can be detected by a base station. In low frequency (LF), omni-directional/quasi omni-directional transmission is performed for each of the messages (MSGs) (e.g., message 1/2/3/4/5) during the LF random access procedure. However, in the HF realm, the UE needs to perform directional transmission for each MSG in random access procedure and which beam to use for each MSG transmission/reception at both the network side and the UE side needs to be considered. Furthermore, different channel reciprocity conditions exist, which can be utilized to optimize the random access procedure to reduce the latency.

Considering the complexity of beamforming, enhancements are required for the random access procedure in the new radio (NR) access system/network to improve reliability and reduce latency.

### SUMMARY

A transmitted reference signal is measured as received through receiver beams having associated receiver beam identities. The reference signal measurements are stored in association with identities of transmitter beams over which the reference signal was transmitted and with the corresponding receiver beam identities to define respective beam link pair measurements. A beam link pair is selected that meets a criterion on the beam link pair measurements and a random access procedure is initiated by transmitting a preamble message over a transmitter beam of the selected beam link pair.

In an embodiment, configuration information that includes physical random access channel resources and transmission reception point transmitting beam relevant is received. In an embodiment, the configuration information is provided through dedicated radio resource control message. In yet another embodiment, each reference signal type is associated with an identifier, and the reference signal type is a DL synchronization signal type or a DL reference signal type.

### BRIEF DESCRIPTION OF DRAWINGS

The accompanying drawings, where like numerals indicate like components, illustrate embodiments of the invention.

FIG. 1 is a schematic system diagram illustrating an exemplary wireless network with HF connections in which the present inventive concept can be embodied.

FIG. 2 is a schematic diagram of a transceiver 100 that may be used in conjunction with embodiments of the present invention.

FIG. 3 is a diagram illustrating exemplary beam training that may be used in conjunction with embodiments of the present invention.

FIG. 4 illustrates an exemplary HF wireless system with multiple beams and multiple TX-RX beam pair measurements.

FIG. 5 illustrates an exemplary beam configuration for UL and DL of the UE in accordance with which the present inventive concept can be embodied.

FIG. 6A is a diagram of an example single TRP deployment in accordance with which the present inventive concept can be embodied.

FIG. 6B is a diagram of an example multiple-TRP deployment in accordance with which the present inventive concept can be embodied.

FIG. 7 is a diagram of a random access procedure in accordance with which the present inventive concept can be embodied.

FIG. 8 is a flow chart for an example random access procedure at the UE side in a HF wireless system in accordance with which the present inventive concept can be embodied.

FIG. 9 is a flow chart for an example random access procedure at the network side in the HF wireless system in accordance with which the present inventive concept can be embodied.

FIG. 10 is a sequence diagram of a conventional random access procedure.

### DETAILED DESCRIPTION

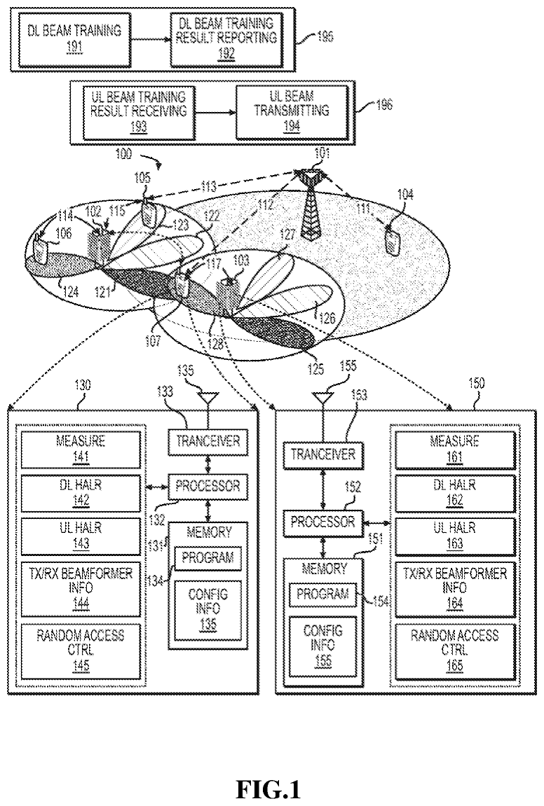

FIG. 1 is a schematic system diagram illustrating an exemplary wireless network 100 with high-frequency (HF) connections in accordance with embodiments of the present invention. Wireless system 100 includes one or more fixed base infrastructure units forming a network distributed over a geographical region. Such a base unit may also be referred as an access point, an access terminal, a base station, a Node-B, an eNode-B (eNB), gNB or by other terminology known in the art. As illustrated in FIG. 1, base stations 101, 102 and 103 serve a number of mobile stations 104, 105, 106 and 107 within a serving area, for example, a cell or a cell sector. In some systems, one or more base stations are coupled to a controller forming an access network that is coupled to one or more core networks. Base station 101 is a conventional base station serving as a macro gNB, while base station 102 and base station 103 are HF base stations, the serving area of which may overlap with serving area of base station 101, as well as may overlap with each other at the edges.

HF base station 102 and HF base station 103 each covers multiple sectors with multiple beams to cover directional areas. Beams 121, 122, 123 and 124 are exemplary beams of base station 102 and beams 125, 126, 127 and 128 are exemplary beams of base station 103. The coverage of HF base station 102 and base station 103 can be scalable based on the number of TRPs radiating the different beams. As an example, user equipment (UE) or mobile station 104 is only in the service area of base station 101 and connected with base station 101 via a link 111. UE 106 is connected with the HF network only, which is covered by beam 124 of base station 102 and is connected with base station 102 via a link 114. UE 105 is in the overlapping service area of base station 101 and base station 102. In one embodiment, UE 105 is configured with dual connectivity and can be simultaneously connected with base station 101 via a link 113 and base station 102 via a link 115. UE 107 is in the service areas of base station 101, base station 102, and base station 103. In one case, UE 107 is configured with dual connectivity and can be connected with base station 101 with a link 112 and base station 103 with a link 117. In another case, UE 107 can switch to a link 116 connecting to base station 102 upon connection failure with base station 103.

FIG. 1 further illustrates simplified block diagrams 130 and 150 for UE 107 and base station 103, respectively. UE 107 has an antenna 135, which transmits and receives radio signals. A RF transceiver 133, such as that described below, may be coupled with the antenna and may receive RF signals from antenna 135, convert them to a baseband signal, and send the baseband signal to processor 132.

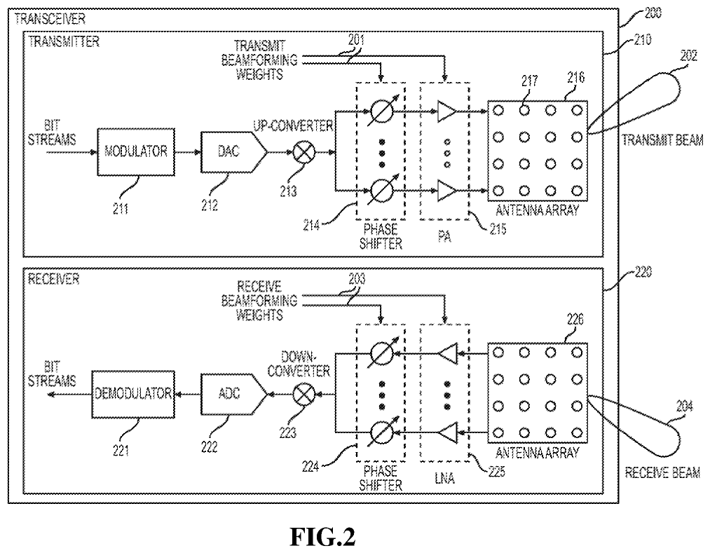

FIG. 2 is a schematic diagram of a transceiver 200 that may be used in conjunction with embodiments of the present invention. Transceiver 200 is capable of beamformed transmission and can be employed in a BS, such as base stations 101-103 or in user equipment (UE), such as user equipment 104-107 of wireless communication system 100. Wireless communication system 100 can implement 5th generation (5G) technologies developed by the 3rd Generation Partnership Project (3GPP). For example, millimeter Wave (mm-Wave) frequency bands and beamforming technologies can be realized in wireless communication system 100.

In beamformed transmission, wireless signal energy can be focused in a specific direction to cover a target serving area. As a result, an increased antenna transmitting gain over an omnidirectional antenna can be achieved. Similarly, in beamformed reception, wireless signal energy received from a specific direction can be combined to obtain a higher antenna receiving gain over an omnidirectional antenna.

As illustrated in FIG. 2, transceiver 200 may include a transmitter 210 and a receiver 220. Transmitter 210 may include a modulator 211, an analog to digital converter (ADC) 212, an up-converter 213, a set of phase shifters 214, a set of power amplifiers (PAs) 215, and an antenna array 216.

Modulator 211 may be configured to receive bitstreams and to generate a modulated signal. The bitstreams may carry control channel information, data channel information, reference signal (RS) sequences, and the like. For example, protocol entities corresponding to different protocol layers in a protocol stack can be created at the BS or UE to facilitate communications between the BS and the UE. The control channel information may include control signaling generated from a physical layer and may be signaled between the BS and the UE, for example, to provide information required for successful demodulation of the data channel information. The data channel information can include data generated or to be received at user applications in the UE, and/or control-plane information generated from a media access control (MAC) layer or from a layer above MAC layer. The data channel information or control channel information can be encoded with various channel coding methods before being received at the modulator 211.

The RS sequences can include different sequences known to both the UE and the BS for various purposes. For example, different RS sequences can be used for channel estimation, beam pair link quality measurement, synchronization or random access during an initial access process, and the like. In one example, the modulator 211 is an orthogonal frequency-division multiplexing (OFDM) modulator. Accordingly, control channel information, data channel information, or RS sequences can be mapped to specific time-frequency resources in an OFDM sub-frame carried in the modulated signal.

DAC 212 may be configured to receive the modulated signal in digital form and generate an analog signal. Up-convertor 213 transfers the analog signal to a carrier frequency band to generate an up-converted signal. The up-converted signal may be split into multiple signals each being conveyed along a separate path. Each separate path can include one of multiple phase shifters 214, one of multiple PAs 215 and an antenna element 217 of the antenna array 216. A set of transmit beamforming weights 201 may be provided to each phase shifter 214 and PA 215 such that each split signal can be delayed and gain-controlled according to a respective beamforming weight 201. In one embodiment, transmit beamforming weights 201 require only phase control on the up-converted signal and are thus applied on phase shifters 214 alone. As a result, the gain of PA 215 is not affected by transmit beamforming weights 201. The output signal from PA 215 is then used for driving antenna array 216.

Antenna elements 217 may be uniformly distributed on a substrate and equally spaced in a vertical or horizontal direction, although the present invention is not so limited. Each antenna element 217, driven by a signal having a specific delay, can radiate a radio wave and propagate in directions based on its antenna radiation pattern. Radio waves from antenna elements 217 can interfere with each other, constructively and destructively, to form a transmit beam 202. Transmit beam 202 includes directionally transmitted wireless signals resulting in signal energy being focused on a particular direction.

In operation, by imposing different sets of beamforming weights 201, transmit beam 202 can be steered in different directions. In addition, the shape of transmit beam 202 can also be modified by adjusting the beamforming weights 201. For example, the width of the transmit beam 202 can be made narrower or wider by adjusting the beamforming weights 201. In some examples, amplitudes of the split signals can be adjusted in combination with adjustments of phases of the split signals to adjust the shape and/or the direction of the transmit beam 202.

Receiver 220 can include a demodulator 221, an analog to digital converter (ADC) 222, a down-converter 223, a set of phase shifters 224, a set of low noise amplifiers (LNAs) 225 and an antenna array 226. Phase shifters 224 and antenna array 226 may have similar structure and function as the phase shifters 214 and the antenna array 216. LNAs 225 amplify signals received from antenna elements of the antenna array 226.

In operation, the phase shifters 224, the LNAs 225, and the antenna array 226 can operate together to form a receive beam 204. Specifically, each antenna element of the antenna array 226 can receive radio signals in directions based on its antenna radiation pattern, and generate an electrical current signal indicating received energy of the radio signals. Each current signal can then be fed to a path including one of the LNAs 225 and one of the phase shifters 224. The LNAs 225 can receive a set of receive beamforming gain-control weights 203. The current signals can be amplified by the LNAs 225 according to the gain-control weights. The phase shifters 224 can receive a set of receive beamforming weights 203, and accordingly cause a delay on each amplified current signal. The gain-controlled and delayed signals can then be combined to generate a combined signal. In alternative examples, the set of receive beamforming weights 203 may only require phase control and are thus not applied to LNAs 225. The amplification, phase shifting and combination operations can result in a receive beam 204. Radio signals received from the direction of the receive beam 204 can be constructively combined in the combined signal while radio signals from other directions can cancel each other in the combined signal.

The down-converter 223 can shift the combined signal from a carrier frequency band to generate a base band analog signal. The ADC 222 can convert the analog signal to a digital signal. The demodulator 221 demodulates the digital signal and generates information bits that may correspond to, for example, control channel information, data channel information, or RS sequences.

While transceiver 200 has an analog beamforming architecture in which analog circuits are employed for beamforming operations, other beamforming architectures can be employed. For example, a transceiver can be built with a digital beamforming architecture in which phase shifting or amplitude scaling are performed over baseband signals with digital processing circuits. Alternatively, a hybrid beamforming architecture can be employed, and digital and analog processing can be performed for beamformed transmission and reception.

Returning to FIG. 1, in one embodiment, the RF transceiver 133 comprises two RF circuits (not illustrated), the first RF circuit is used for HF transmitting and receiving, and another RF circuit is used for transmitting and receiving in different frequency bands that are different from the HF transmitting and receiving. RF transceiver 133 may also convert the baseband signals received from processor 132 into RF signals and send the RF signals out through antenna 135, as described above.

Example processor 132 processes the received baseband signals and invokes various functions that perform features in UE 107. Memory 131 stores program instructions and data in storage area 134 and configuration information in storage area 135 to control the operations of UE 107. UE 107 may include multiple functional components or modules/circuits that carry out different tasks in accordance with embodiments of the present invention. A measurement controller 141 controls both layer 1 (L1; physical layer) and layer 3 (L3 on which radio resource control (RRC) is implemented) measurements on individual beams and generates the measurement results. L1 measurements include measurements from which channel state information (CSI) and L1-RSRP (reference signal received power) are derived to support dynamic scheduling and L3 measurements include radio resource management (RRM) measurements from which cell-level quality is derived to support UE mobility over different cells. As used herein, an L1 measurement refers to the measurement to derive CSI, L1-RSRP to support dynamic scheduling and an L3 measurement refers an RRM measurement to derive cell-level quality to support UE mobility over different cells.

Example downlink (DL) handler 142 performs DL beam measurement and training with different TRP Tx beams through different UE Rx beams. An uplink (UL) handler 143 determines the UE Tx beam and the transmission format for each UL transmission. In embodiments of the invention, a Tx/Rx beamformer information handler 144 stores the Tx/Rx beamforming information (e.g., beamforming weights) for both DL and UL, i.e., best TRP Tx-UE Rx pair information for DL reception and best UE Tx-TRP Rx pair information for UL transmission. A random access controller 145 determines how to transmit/receive each random access procedure MSG and what information is to be carried/derived in each MSG. In one embodiment, measurement controller 141, DL handler 142 and UL handler 143 are combined in one component or module and Tx/Rx beamformer information handler 144 may be implemented in the memory 131.

Similarly, base station 103 has an antenna 155, which transmits and receives radio signals. A RF transceiver 153 is coupled to antenna 155 to receive RF signals from antenna 155, converts them to baseband signals, and sends them to processor 152. RF transceiver 153 also converts received baseband signals from processor 152, converts them to RF signals, and sends out to antenna 155. RF transceiver 153 may be implemented similar to that described above for transceiver 200.

Processor 152 of base station 103 processes the received baseband signals and invokes different functional modules to perform features in base station 103. Memory 151 stores program instructions and data 154 and the configuration information 155 to control the operations of base station 103. Base station 103 may also include multiple function modules that carry out different tasks in accordance with embodiments of the current invention. A measurement controller 161 controls the measurement behavior at the network side and receives the measurement results from the UE side. A DL handler 162 determines the TRP Tx beam and the transmission format for each DL transmission. A UL handler 143 performs UL beam measurement and training with different UE Tx beam through different TRP Rx beam. A Tx/Rx beamformer information handler 164 stores the Tx/Rx beamformer information for both DL and UL, i.e best TRP Tx-UE Rx pair information for DL reception and best UE Tx-TRP Rx pair information for UL transmission. A random access controller 165 determines how to transmit/receive each MSG and what information carried/derived in each MSG. Measurement controller 161, DL handler 162 and UL handler 163 may be combined in one module, and Tx/Rx beamformer information handler 164 could be implemented in the memory 151.

It is to be understood that the storage areas and memory described herein may be implemented by any quantity of any type of conventional or other memory or storage device, and may be volatile (e.g., RAM, cache, flash, etc.), or non-volatile (e.g., ROM, hard-disk, optical storage, etc.), and include any suitable storage capacity. Additionally, the processors described herein are, for example, one or more data processing devices such as microprocessors, microcontrollers, systems on a chip (SOCs), or other fixed or programmable logic, that executes instructions for process logic stored in the memory. The processors may themselves be multi-processors, and have multiple CPUs, multiple cores, multiple dies comprising multiple processors, etc.

FIG. 1 further shows functional components that handle DL transmission and UL transmission during the random access procedure in the HF system. For DL reception 195, UE 105 has a DL beam training component 191 and a DL beam training result reporting component 192. For UL transmission, UE 105 has a UL beam transmitting component 193 and a UL beam training result receiving component 194. It is to be understood that the functional components could be implemented by dedicated circuitry or by software executing on programmable processing logic, or a combination thereof, or combined into processors 132 and 152, respectively.

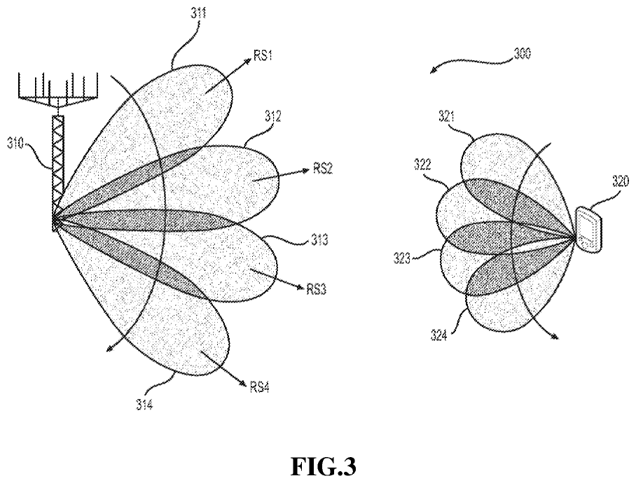

FIG. 3 shows an example beam training process 300 according to an embodiment of the present invention. Beam training process 300 may be performed to select a beam pair link based on measurements of multiple possible beam pair links between a BS 310 and a UE 320. The selected beam pair link can be used for later communication between the BS 310 and the UE 320. A beam pair link, as used herein, refers to a communication link between a BS and a UE formed with a pair of receive beam and transmit beam being used between the BS and the UE. For a certain environment of the BS and the UE, different beam pair links can have different characteristics for measurement. Among them, a beam pair link can be selected for communications between the BS and the UE. The selection can be based on, for example, the best measurement results for a particular beam pair link.

The BS 310 may be part of a wireless communication network in which mm-Wave frequency bands and beamformed transmission are employed. The BS 310 can employ a beamforming transceiver, such as the transceiver 200 of FIG. 2, to generate one transmit beam at a time or multiple transmit beams simultaneously. In the FIG. 3 example, four transmit beams 311-314 can be generated successively to cover a serving region of the base station 310. The serving region may be a sector of a larger serving area of the BS station.

UE 320 is located within the exemplary serving region covered by the four transmit beams 311-314. The UE 320 can be a mobile phone, a laptop computer, a vehicle-carried mobile communication device, and the like. Similarly, the UE 320 can employ a beamforming transceiver, such as the transceiver 200 of FIG. 2, to generate one receive beam at a time or multiple receive beams simultaneously. In the FIG. 3 example, four receive beams 321-324 can be successively generated to cover a receiving area.

Beam training process 300 can include two stages. At a first stage, a beam pair measurement process can be performed. Specifically, BS 310 can generate the transmit beams 311-314 successively sweeping the covered sector. Each transmit beam 311-314 can carry RS resources RS1-RS4, identified by a reference signal IDs. While one of the transmit beams 311-314 is being transmitted, UE 320 can rotate through the four receive beams 321-324 in, for example different transmission occasions of individual transmit beams 311-314. In this way, all combinations of beam pairs between the transmit beams 311-314 and receive beams 321-324 can be established and investigated. For example, for each beam pair, the UE 320 can employ the RS resources such as CSI-RS reference signal received power (RSRP), for the respective beam pair link.

At a second stage, a beam pair link for downlink communication between the BS 310 and the UE 320 can be determined. In one example, a measurement report including the measurements can be provided to the BS 310 from the UE 320. The BS 310 subsequently makes a decision and informs the UE 320 of the selection. In either case, a DL beam index is assigned by the network, and the corresponding receiver beam for the DL beam is maintained at the UE side.

In one novel aspect, DL beam training component 191 monitors and measures different beams transmitted by the network. In one embodiment, the different beams are transmitted through beam sweeping. In another embodiment, parts of the beams are transmitted one or multiple times. In another embodiment, single beam (omni-directional beam) is used. In one embodiment, a UE performs beam training based on the sweeping beams broadcast by the network before random access procedure. In another embodiment, UE performs DL beam training on multiple beams for random access response (RAR) reception during random access procedure.

In one novel aspect, the different beams are transmitted by the network using DL signals. In one embodiment, the different beams are transmitted through DL synchronization signals. In one embodiment, the different beams are transmitted through DL reference signals, e.g., beam specific channel state information reference signal (CSI-RS). In one embodiment, different signals corresponding to different beams are associated with an identity (ID). In another embodiment, each of different signals corresponding to different beams is associated with an identity. In one embodiment, the identity is detected from the signal sequence. In another embodiment, the identity for each signal/beam is assigned by the network through RRC configuration.

In one novel aspect, a DL beam training result reporting component 192 informs the network about the DL beam training result, e.g., one or multiple TRP Tx beams with best measurement result. The measurement result can be an L1 measurement result, e.g. CSI, L1-RSRP, or an L3 measurement result. The information is carried in the subsequent UL transmission or in a measurement report.

In one novel aspect, UL beam training results receiving component 193 receives the UL beam training result from the network. In one embodiment, the network performs UL beam training, so that the UE transmits MSG1 during the random access (RA) procedure through multiple rounds of beam sweeping. UL beam transmitting component 194 transmits UL MSGs with different transmission formats. The transmission format depends on the availability of channel reciprocity at the UE side and the UL beam training result. In one embodiment, the network provides a random access configuration for MSG1, the IDs for TRP Tx beams, and the associations between each physical random access channel (PRACH) resource and the TRP Tx beam. In one embodiment, the TRP Tx beam corresponds with a DL reference signal, e.g. CSI-RS or demodulation reference signal (DMRS) (e.g., DMRS for physical broadcast channel (PBCH) or broadcast channel demodulation).

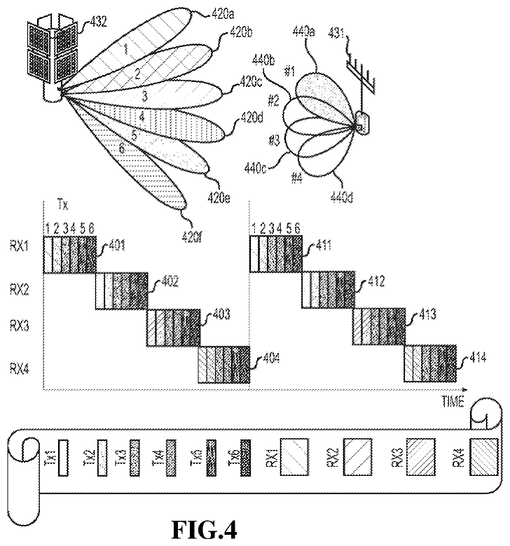

FIG. 4 is an illustration of an exemplary HF wireless system 400 with multiple beams as well as a diagram of multiple TX-RX beam pair measurements. A UE 431 camps on a cell covered by an HF base station 432. HF base station 432 may be configured to directionally cover multiple sectors/cells with each sector/cell being covered by a set of coarse TX beams. In one embodiment, each cell is covered by six such control beams. Different beams are time division multiplexed and distinguishable and the set is transmitted repeatedly and periodically. UE 431 may have a set of directional beams for transmission and reception. In the illustrated example, UE 431 has a set of four such beams 440a-440d, or RX1-RX4. Six TRP TX beams 420a-420f, or TX1-TX6 are measured with each UE RX beams 420a-420d, or RX1-RX4. As illustrated in FIG. 3, measurements 401 contain measurement samples of TX1-RX1, TX2-RX1, TX3-RX1, TX4-RX1, TX5-RX1, and TX6-RX1. Similarly, measurements 402 contain measurement samples of TX1-RX2, TX2-RX2, TX3-RX2, TX4-RX2, TX5-RX2, and TX6-RX2. Measurements 403 and 404 are similarly obtained for RX3 and RX4. Subsequently, the procedure is repeated to generate measurement samples 411, 412, 413, and 414. With those measurement results for each TRP Tx-UE Rx pair, UE 431 can find one or more TRP Tx beams with best measurement results as well as the corresponding UE Rx beams. The same procedure can also be applied to UL; the network may measure each UE Tx-TRP Rx pair and derive the measurement results for each pair so that the network can find one or more UE Tx beams with best measurement results as well as the corresponding TRP Rx beam(s). The measurement behavior performed by UE is applied in both IDLE and CONNECTED. In IDLE mode, UE relies on the procedure for cell selection/reselection and PRACH resource selection; In CONNECTED mode, UE relies on the procedure for HO and PRACH resource selection towards the target cell.

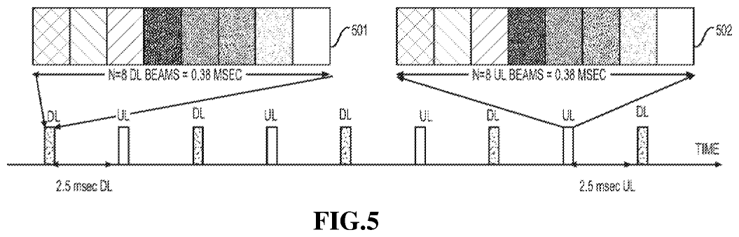

FIG. 5 illustrates an exemplary beam configuration for UL and DL of a UE in accordance with the present invention. A beam pair link is a combination of downlink and uplink resources, e.g., association of the resources in frequency/spatial/time domain. The linking between the beam of the DL resource and the beam of the UL resources is indicated explicitly in the system information or beam-specific information. It can also be derived implicitly based on some rules, such as the interval between DL and UL transmission opportunities. In one embodiment, a DL frame 501 is of sufficient length, e.g., 0.38 ms to cycle through eight different DL beams. A UL frame 502 is of sufficient length, e.g., 0.38 ms, to cycle through eight UL beams. The interval between the UL frame and the DL frame is 2.5 msec. The pairing of DL and UL beams manifests itself on the time interval between instances in which the beams are active. Such information may be used to identify a particular DL and UL beam pair, e.g., the third DL beam in a DL frame and the fourth UL beam in a successive DL frame is (8−3)*0.38+2.5+4*0.38=5.92 ms.

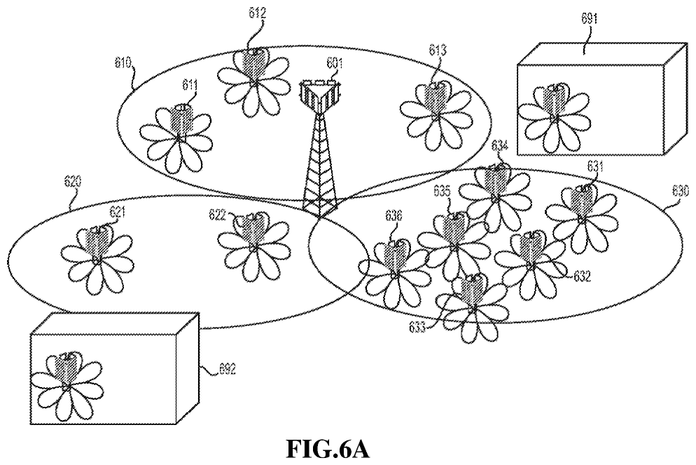

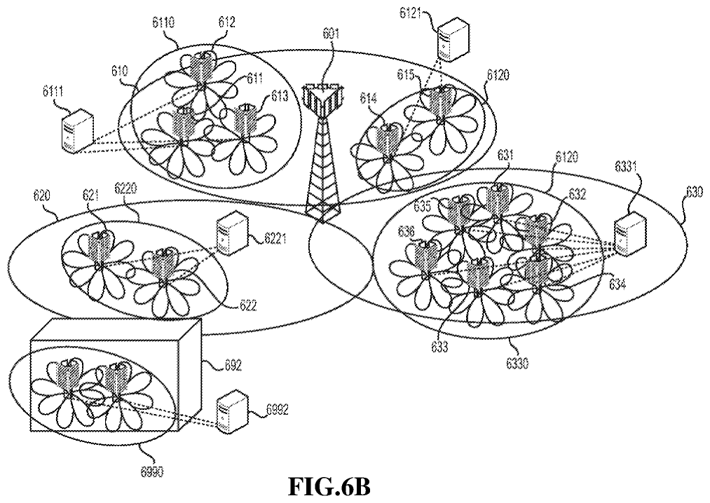

FIG. 6A shows an exemplary diagram of single TRP deployment in accordance with embodiments of the present invention. Areas 610,620 and 630 are served by multiple HF base stations: area 610 includes HF base stations 611, 612, and 613; area 620 includes HF base stations 621 and 622; and area 630 includes HF base stations 631, 632, 633, 634, 635, and 636. A macro-cell base station 601 may assist the non-stand-alone HF base stations. FIG. 6A also illustrates two exemplary standalone HF base stations, 691 and 692.

FIG. 6B shows an exemplary diagram of multiple-TRP deployment in accordance with embodiments of the present invention. Areas 610,620 and 630 are served by multiple HF base stations, some forming multiple cells by multiple-TRP deployment. In the multiple-TRP deployment, multiple TRPs are connected to a 5G node through ideal backhaul/fronthaul. With multiple-TRP deployment, the cell size is scalable and can be very large.

Area 610,620 and 630 are served by one or more multiple-TRP cells. Area 610 is served by two multiple-TRP cells 6110 and 6120. Multiple TRPs 611, 612, and 613 are connected with a 5G node 6111 forming cell 6110. Multiple TRPs 614, and 615 are connected with a 5G node 6121 forming cell 6120. Similarly, area 620 is served by a multiple-TRP cell 6220. Multiple TRPs 621 and 622 are connected with a 5G node 6221 forming cell 6220. Area 630 is served by a multiple-TRP cell 6330. Multiple TRPs 631-636 are connected with a 5G node 6331 forming cell 6330. Standalone cells can also be formed with multiple-TRPs. Multiple TRPs are connected with a 5G node 6992 forming standalone cell 6990.

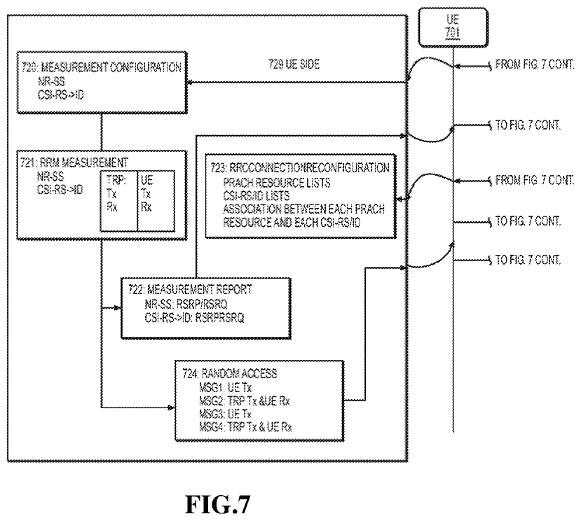

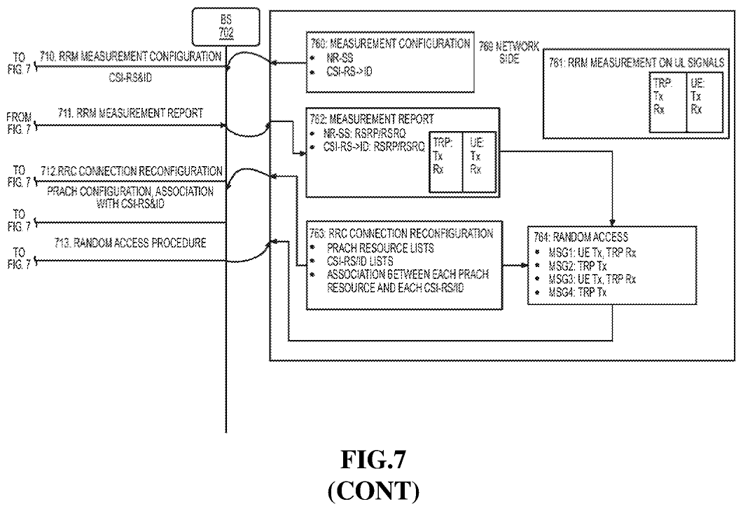

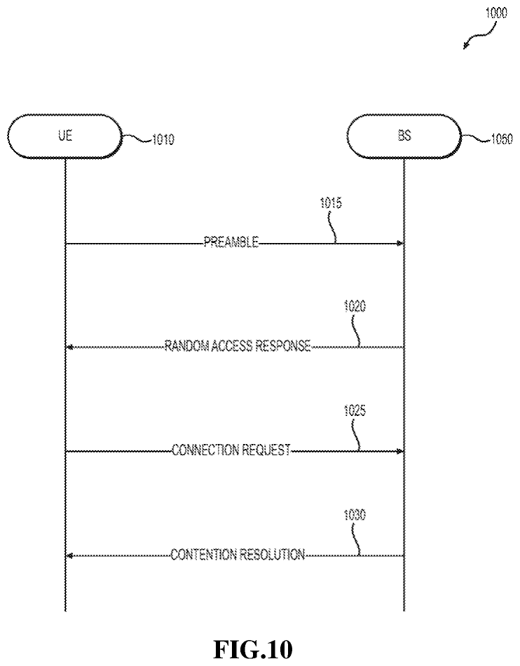

FIG. 7 illustrates a diagram of an exemplary random access procedure between a UE 701 and a base station 702 in accordance with embodiments of the present invention. Generally, there are two types of random access procedure, i.e., contention based random access (the 4-step process illustrated in FIG. 10, for example) and contention free random access (a 2-step process where contention is not an issue). The process described with reference to FIG. 7 is applicable to both contention-based and contention-free random access.

It is to be understood that the “network” entity performing network operations described herein could be the base station or an entity belonging to the core network. For communications, e.g., transmitting and receiving, the entity performing the function is typically the base station while for determining and configuring, the entity performing the function could be the same base station, but may also be another entity belonging to the access network, or the core network, as is known to skilled artisans. Thus, the entity referred to herein as “network” could be the entities indicated above based on the different functions performed, which are not described in detail herein for succinctness.

As illustrated in FIG. 7, measurement configuration 760 indicates whether DL synchronization signal (e.g., new radio synchronization signal (NR-SS)) or DL reference signals (e.g., channel state information reference signal (CSI-RS)) or both are used for radio resource management (RRM) measurements. Furthermore, each of these DL signals is associated with an identity, which can be derived implicitly from the signal sequence or assigned explicitly by network 769. Each DL signal may correspond with a DL beam and, thus, the DL beam may be identified by the DL signal ID.

UE 701 may receive an RRM measurement configuration message 710 from the network 769, which can be broadcast or on a dedicated channel configured by base station 702. Receipt of RRM measurement configuration 720 initiates UE side behavior 729. UE 701 may perform measurements 721 on the DL signals. For example, UE 701 may perform, using different UE Rx beams, an L1 measurement or an L3 measurement or both L1 and L3 measurements on the DL signals. Through the beam measurement results, different DL beam link pairs, e.g., TRP Tx-UE Rx pairs, can be derived. The measurement results and the corresponding beam identities for each DL beam link pair are stored in memory at UE side 729. The measurement results may also be formatted into a measurement report 722 and when certain measurement report events are triggered, UE 701 sends measurement report to the network 769 in operation 711. Measurement results 762 contains L1 measurement results, L3 measurement results or both for each beam associated by an ID. Measurement results 762 contains cell-level measurement results, representing the overall channel quality. Measurement results 762 and the corresponding beam identity for each DL beam are stored in memory at the network side 769.

Optionally, network 769 may perform measurements on UL signals 761. Network 769 performs L1, L3, or both L1 and L3 measurement on the UL signals through different TRP Rx beams. So the beam measurement results for different UL beam link pairs, e.g., TRP Rx-UE Tx pairs, can be derived. The measurement result and the corresponding beam identities for each UL beam link pair may also be stored at the network side 769.

Network side 769 may generate an RRC configuration for random access 763 according to the measurement results at the network side as well as the measurement report provided by the UE. The configuration 763 includes PRACH resource lists, CSI-RS ID/SSB lists and the association between each PRACH resource and the CSI-RS/SSB. UE 701 may receive the RRC configuration for random access 723 from the network in operation 712. Based on the configuration 723 and the measurement results with corresponding beam information 721, UE 701 may initiate a random access procedure 713 by transmitting preambles using the appropriate UL beam pair information 724. During the random access procedure 713, UE selects proper TRP Tx beams and corresponding UE Rx beams for DL signal reception, and selects proper UE Tx beams assuming certain TRP Rx beams for UL signal transmission. Similarly, during random access procedure 713, network selects proper TRP Tx beams assuming certain UE Rx beams for DL signal transmission, and selects proper UE Tx beams and the corresponding TRP Rx beams for UL signal reception, as illustrated at 764.

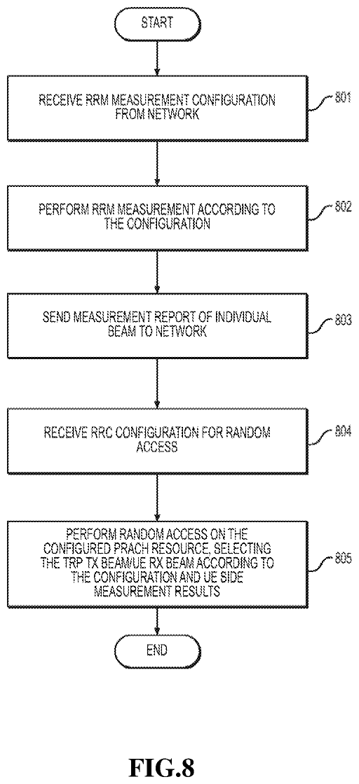

FIG. 8 is a flow diagram of an exemplary random access procedure from the UE perspective in a HF wireless system in accordance with embodiments of the present invention. In operation 801, the UE receives RRM configuration information from the network side, which indicates which DL signal are used for RRM. It also indicates an association between each DL signal, e.g., CSI-RS, and an ID. It also indicates whether L1, L3 or both L1 and L3 measurement results will be included in a subsequently issued measurement report. In operation 802, UE performs measurement on DL synchronization signal (NR-SS), DL reference signal (CSI-RS) or both according to the configuration in operation 801. In operation 803, UE sends the measurement report to the network, which includes the measurement results of each individual beam. In operation 804, UE receives the random access configuration, which includes the information for PRACH resource lists, the TRP Tx beam lists and the association between each PRACH resource and the TRP Tx beam. In operation 805, UE initiates random access procedure using the PRACH resources configured in operation 804 for MSG1 transmission and receiving MSG2 from the associated TRP Tx beam.

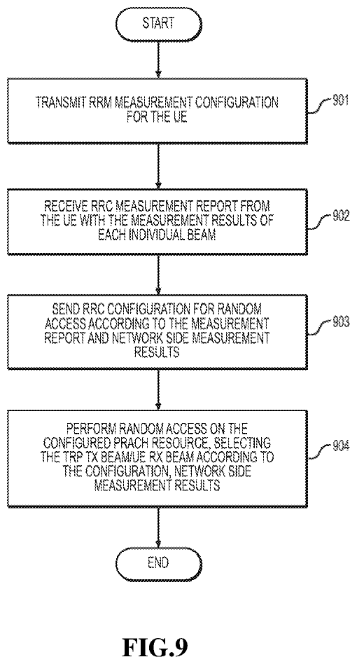

FIG. 9i s a flow diagram of an exemplary random access procedure from the network perspective in the HF wireless system in accordance with embodiments of the present invention. In operation 901, the network provides RRM configuration to the UE, which indicates which DL signal(s) are used for RRM. It also indicates an association between each DL signal, e.g. CSI-RS, and an ID. It also indicates whether L1, L3 or both L1 and L3 measurement results will be included in the measurement report. The configuration can either be provided through system information or dedicated RRC signaling. In operation 902, the network receives a measurement report from the UE, which includes the measurement results of each individual beam. In operation 903, the network transmits the random access configuration, which includes the information for PRACH resource lists, the TRP Tx beam lists and the association between each PRACH resource and the corresponding TRP Tx beam. The network makes the configuration according to the measurement report provided from the UE side as well as the measurement results on UL signals derived from the network side. In operation 904, the network performs random access procedure, receiving preambles from the UE on the PRACH resources configured in operation 803 and transmitting MSG2 with the associated TRP Tx beams.

Apparatus and methods are provided to perform a random access procedure in a NR access system. In one novel aspect, the UE performs a measurement on each individual beam and sends the measurement results of each individual beam to the network. The UE receives a radio resource control (RRC) configuration for random access procedure, and performs the random access procedure according to the configuration and the UE side measurement results.

In one novel aspect, the network provides a radio resource management (RRM) measurement configuration to each UE, requiring measurement results for each individual beam. Then the network receives the measurement results for each individual beam from the UE and provides the RRC configuration for random access to the UE according to the received measurement results. The network performs the random access procedure according to the configuration, UE side measurement results, and network side measurement results based on uplink (UL) signals.

In one embodiment, each individual beam corresponds with one physical signal, which can be a synchronization signal or a reference signal, e.g. channel state indication reference signal (CSI-RS). Each individual beam is associated with an identity, which can be derived implicitly from a sequence in the signal or be assigned explicitly by the network.

In one embodiment, the measurement results for each individual beam can be layer 1 (L1) measurement results and RRM measurement results. The measurement reports for each individual beam sent by the UE can be L1 measurement results (e.g., beam specific channel quality indicator (CQI) report) or RRM measurement results (e.g., beam specific reference signal received power (RSRP)/RSRQ (reference signal received quality) report).

In one embodiment, the configuration for random access contains information for a physical random access channel (PRACH) resources, or beam IDs associated with the physical signals, or the association between each PRACH resource and the beam ID(s), or any combination of the above elements.

In one embodiment, the UE selects the transmission and reception point (TRP) transmitter (Tx) beam(s) as well as the corresponding UE receiver (Rx) beam(s), i.e., UE Rx beam pair, for downlink (DL) signal reception during the random access procedure. The UE selects the UE Tx beam(s) assuming certain TRP Rx beam(s), i.e., UE Tx beam pair(s), are used by the network for UL signal transmission. The selection or pairing is based on the configuration for random access and the UE side measurement result and/or UE Rx beam sweeping.

In another embodiment, the network selects the TRP Tx beam(s) assuming certain UE Rx beam(s), i.e., TRP Tx beam pair, for DL signal transmission during random access procedure. The network selects the UE Tx beam(s) assuming as well that the corresponding TRP Rx beam(s) are used by the network, i.e., TRP Rx beam pair, for UL signal reception. The selection is based on the configuration for random access, UE side measurement result reported and the network side measurement result on UL signals.

In yet another embodiment, the configuration for random access can be provided through the dedicated RRC message, or broadcasted through the system information (SI).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a solid state disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a phase change memory storage device, or any suitable combination of the foregoing. In the context of this document, a computer readable storage medium may be any tangible medium that can contain, or store a program for use by or in connection with an instruction execution system, apparatus, or device.

The flowchart and block diagrams in the figures illustrate the architecture, functionality, and operation of possible implementations of systems, method and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometime be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

1. A method of random access to a random access network, the method comprising:
measuring a transmitted reference signal as received through receiver beams having associated receiver beam identities;
storing the reference signal measurements in association with identities of transmitter beams over which the reference signal was transmitted and the corresponding receiver beam identities to define respective beam link pair measurements;
selecting a beam link pair that meets a criterion on the beam link pair measurements;
initiating a random access procedure by transmitting a preamble message over a transmitter beam of the selected beam link pair.

2. The method of claim 1 further comprising:
receiving an indication of the transmitter beam identities with the reference signal.

3. The method of claim 2 further comprising:
deriving the transmitter beam identities from a signal sequence of the reference signal.

4. The method of claim 1 further comprising:
receiving configuration information that includes physical random access channel (PRACH) resources and transmission reception point (TRP) transmitting (Tx) beam relevant information.

5. The method of claim 4, further comprising:
providing the configuration information through dedicated radio resource control (RRC) message or broadcast by system information.

6. The method of claim 4, wherein the configuration information further indicates the association between each PRACH resource and each TRP Tx beam.

7. The method of claim 4 further comprising:
initiating the random access procedure by transmitting the preamble message using the PRACH resources and indicating the TRP Tx beam of the selected beam link pair on which a response to the preamble message is to be transmitted; and
receiving a response to the preamble using the PRACH resources of the selected beam link pair.

8. The method of claim 1 further comprising:
receiving measurement configuration information from a network entity that indicates a reference signal type to be measured;
measuring the reference signal according to the reference signal type indicated in the measurement configuration information; and
sending the reference signal measurements to the network entity.

9. The method of claim 6, wherein the measurement configuration information further indicates whether layer 1 (L1) or layer 3 (L3) measurement results are provide in a measurement report for each individual beam.

10. The method of claim 1, further comprising:
associating each reference signal type with an identifier (ID), wherein the reference signal type is a DL synchronization signal type or a DL reference signal type.

11. An apparatus comprising:
a processor, configured to:
measure a transmitted reference signal as received through receiver beams having associated receiver beam identities;
store the reference signal measurements in association with identities of transmitter beams over which the reference signal was transmitted and the corresponding receiver beam identities to define respective beam link pair measurements;
select a beam link pair that meets a criterion on the beam link pair measurements;
initiate the random access procedure by transmitting a preamble message over a transmitter beam of the selected beam link pair.

12. The apparatus of claim 11 wherein the processor is further configured to:
receive configuration information that includes physical random access channel (PRACH) resources and transmission reception point (TRP) transmitting (Tx) beam relevant information.

13. The apparatus of claim 12, wherein the processor is further configured to:
provide the configuration information through dedicated radio resource control (RRC) message or broadcast by system information.

14. The apparatus of claim 12, wherein the configuration information further indicates the association between each PRACH resource and each TRP Tx beam.

15. The apparatus of claim 12, wherein the processor is further configured to:
initiate the random access procedure by transmitting the preamble message using the PRACH resources and indicating the TRP Tx beam of the selected beam link pair on which a response to the preamble message is to be transmitted; and
receive a response to the preamble using the PRACH resources of the selected beam link pair.

16. The apparatus of claim 11, wherein the processor is further configured to:
receive measurement configuration information from a network entity that indicates a reference signal type to be measured;
measure the reference signal according to the reference signal type indicated in the measurement configuration information; and
send the reference signal measurements to the network entity.

17. The apparatus of claim 11, wherein the processor is further configured to:
associate each reference signal type with an identifier (ID), wherein the reference signal type is a DL synchronization signal type or a DL reference signal type.

18. A computer readable medium, storing instructions that, when executed by a processor, compels the processor to:
measure a transmitted reference signal as received through receiver beams having associated receiver beam identities;
store the reference signal measurements in association with identities of transmitter beams over which the reference signal was transmitted and the corresponding receiver beam identities to define respective beam link pair measurements;
select a beam link pair that meets a criterion on the beam link pair measurements;
initiate a random access procedure by transmitting a preamble message over a transmitter beam of the selected beam link pair.

19. The computer readable medium of claim 18, storing additional instructions that compel the processor to:
receive configuration information that includes physical random access channel (PRACH) resources and transmission reception point (TRP)transmitting (Tx) beam relevant information.
